(19) United States
(12) Patent Application Publication
(10) Pub. No.: US 2012/0051235 A1
(43) Pub. Date: Mar. 1, 2012

(54) ADVANCED ADMISSION CONTROL OVER ALL INTERNET PROTOCOL (IP) WIRELESS ACCESS NETWORKS

(75) Inventors: Lalit R. Kotecha, San Ramon, CA (US); Sergio Aguirre, Southlake, TX (US); Jin Yang, Orinda, CA (US); Yee Sin Chan, San Jose, CA (US)

(73) Assignee: VERIZON PATENT AND LICENSING INC., Basking Ridge, NJ (US)

(21) Appl. No.: 12/862,447

(22) Filed: Aug. 24, 2010

(51) Int. Cl. H04L 12/26

(52) U.S. Cl. 370/252

(57) ABSTRACT

A device receives a priority configuration for a subscriber associated with a user device, and monitors resource utilization information associated with an Internet protocol (IP) wireless access network of the user device. The device also detects an initial attach request of the user device to the IP wireless access network, and determines whether to accept or deny the initial attach request based on the subscriber priority configuration and the resource utilization information. The device further provides, to the user device and when the initial attach request is denied, a time for the user device to attempt a re-attach to the IP wireless access network, and permits, when the initial attach request is accepted, the user device to access the IP wireless access network.

### BACKGROUND

As wireless network data rates improve using third generation (3G), fourth generation (4G), and WiFi technologies, more and more bandwidth-intensive applications are being developed. A 4G wireless network is an all Internet protocol (IP) wireless access network in which different advanced multimedia application services (e.g., voice over IP (VoIP) content, video content, etc.) are delivered over IP. In a multiple access network, these different multimedia application services compete for the same air interface and transport network resources. At the same time, mission critical application services (e.g., enhanced 911 (or E911) services, public safety services, government security services, etc.) may share the same air interface and transport network resources as the ordinary multimedia application services. However, such application services may not be prioritized, which may adversely affect service provisioning and network operation.

### BRIEF DESCRIPTION OF THE DRAWINGS

FIG. 1 is a diagram of an example network in which systems and/or methods described herein may be implemented;

FIG. 2 is a diagram of example components of one or more of the devices of the network depicted in FIG. 1;

FIG. 3 is a diagram of example interactions between components of an example portion of the network depicted in FIG. 1;

FIG. 4 is a diagram of example interactions between components of another example portion of the network illustrated in FIG. 1;

FIG. 5 is a flow diagram of example interactions between components of still another example portion of the network depicted in FIG. 1; and

FIGS. 6-7B are flow charts of example processes for providing advanced admission control over an all IP wireless access network according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may provide advanced admission control (e.g., for prioritizing services) in an IP wireless access network. The systems and/or methods may provide subscriber-based and application services-based priority access to the IP wireless access network, which may ensure proper service provisioning and operation of the IP wireless access network.

In one example implementation, the systems and/or methods may receive a priority configuration for a subscriber and/or an application service associated with a user device, and may monitor resource utilization information associated with an IP wireless access network of the user device. The systems and/or methods may detect an initial attach request of the user device to the IP wireless access network, and may report the monitored resource utilization information upon detection of the initial attach request. The systems and/or methods may determine whether to accept or deny the initial attach request based on the subscriber priority configuration and/or the monitored resource utilization information. If the initial attach request is denied (e.g., based on the determination), the systems and/or methods may provide, to the user device, a time to attempt a re-attach to the IP wireless access network. If the initial attach request is accepted (e.g., based on the determination), the systems and/or methods may permit the user device to access the IP wireless access network.

In another implementation, for example, the systems and/or methods may receive a priority configuration for a subscriber and/or an application service associated with a user device, and may provide the priority configuration to a base station associated with an IP wireless access network of the user device. The systems and/or methods may receive, from the base station, resource utilization information associated with the IP wireless access network when the user device attempts to initially attach to the IP wireless access network. The systems and/or methods may determine, based on the resource utilization information, a time for the user device to attempt a re-attach to the IP wireless access network when the user device is denied access to the IP wireless access network, and may provide the determined time to the user device. The systems and/or methods may receive an application service request from the user device when the user device is provided access to the IP wireless access network, and may determine whether to accept or deny the application service request based on the application service priority configuration and/or the resource utilization information. If the application service request is denied (e.g., based on the determination), the systems and/or methods may provide, to the user device, a time to re-attempt the application service request. If the application service request is accepted (e.g., based on the determination), the systems and/or methods may permit the user device to receive the application service via the IP wireless access network.

As used herein, the terms “subscriber” and/or “user” may be used interchangeably. Also, the terms “subscriber” and/or “user” are intended to be broadly interpreted to include a user device (e.g., a mobile telephone, a personal computer, a set-top box, a television, etc.) or a user of a user device.

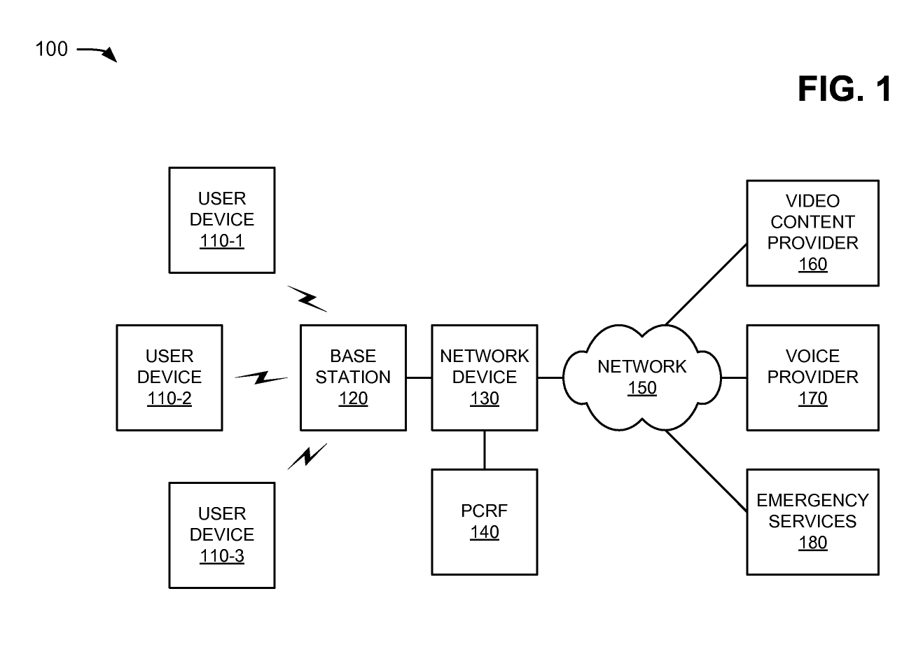

FIG. 1 is a diagram of an example network 100 in which systems and/or methods described herein may be implemented. As illustrated, network 100 may include three user devices 110-1, 110-2, and 110-3 (collectively referred to herein as “user devices 110,” and, in some instances, singularly as “user device 110”), a base station 120, a network device 130, a policy and charging rules function (PCRF) 140, a network 150, a video content provider 160, a voice provider 170, and an emergency services provider 180. Components of network 100 may interconnect via wired and/or wireless connections. Three user devices 110, a single base station 120, a single network device 130, a single PCRF 140, a single network 150, a single video content provider 160, a single voice provider 170, and a single emergency services provider 180 have been illustrated in FIG. 1 for simplicity. In practice, there may be more user devices 110, base stations 120, network devices 130, PCRFs 140, networks 150, video content providers 160, voice providers 170, and/or emergency services providers 180.

User device 110 may include any device that is capable of communicating with video content provider 160, voice provider 170, and/or emergency services provider 180 via an IP wireless access network (e.g., provided by base station 120 and/or network device 130). For example, user device 110 may include a mobile computation and/or communication device, such as a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a wireless device, a smart phone, a laptop computer (e.g., with a wireless air card), a global positioning system (GPS) device, a content recording device (e.g., a camera, a video camera, etc.), etc. In another example, user device 110 may include a fixed (e.g., provided in a particular location, such as within a customer's home) computation and/or communication device, such as a laptop computer, a personal computer, a tablet computer, a set-top box (STB), a television, a gaming system, etc.

Base station 120 may include one or more computation and/or communication devices that receive voice and/or data (e.g., video content and/or emergency services) from video content provider 160, voice provider 170, and/or emergency services provider 180 (e.g., via network device 130 and network 150) and transmit that voice and/or data to user device 110. Base station 120 may also include one or more devices that receive voice and/or data (e.g., a request for video content) from user device 110 and transmit that voice and/or data to video content provider 160, voice provider 170, and/or emergency services provider 180 (e.g., via network device 130 and network 150).

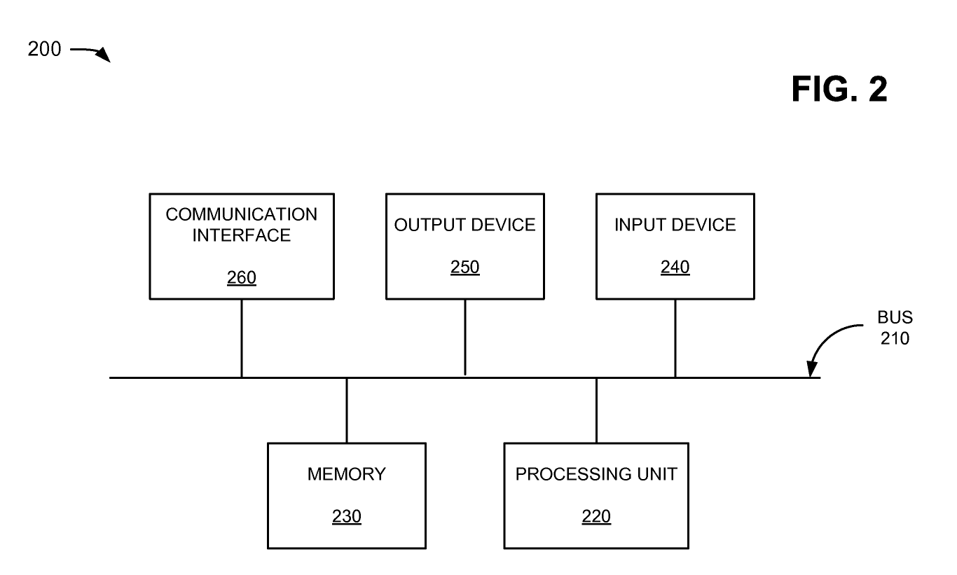

In one example implementation, base station 120 may receive a priority configuration for a subscriber and/or an application service associated with user device 110, and may monitor resource utilization information associated with an IP wireless access network (e.g., provided by base station 120 and/or network device 130). Base station 120 may detect an initial attach request of user device 110 to the IP wireless access network, and may report (e.g., to network device 130) the resource utilization information upon detection of the initial attach request. Base station 120 may determine whether to accept or deny the initial attach request based on the subscriber priority configuration and/or the resource utilization information. If the initial attach request is denied (e.g., based on the determination), base station 120 may provide, to user device 110, a time to attempt a re-attach to the IP wireless access network. If the initial attach request is accepted (e.g., based on the determination), base station 120 may permit user device 110 to access the IP wireless access network. Further details of base station 120 are provided below in connection with one or more of FIGS. 2-5.

Network device 130 may include one or more data transfer devices, such as a gateway, a router, a switch, a firewall, a network interface card (NIC), a hub, a bridge, a proxy server, an optical add-drop multiplexer (OADM), or some other type of device that processes and/or transfers data. In one example, network device 130 may include a radio access controller (e.g., a mobility management entity (MME)) that provides a convergence point between wireless protocols (e.g., associated with user device 110 and/or base station 120) and IP protocols (e.g., associated with PCRF 140, network 150, video content provider 160, voice provider 170, and/or emergency services provider 180). Network device 130 may route packets (or portions of packets) from a wireless network (e.g., user device 110 and base station 120) to another network (e.g., network 150).

In one example implementation, network device 130 may receive a priority configuration for a subscriber and/or an application service associated with user device 110, and may provide the priority configuration to base station 120. Network device 130 may receive, from base station 120, resource utilization information associated with an IP wireless access network (e.g., provided by base station 120 and/or network device 130) when user device 110 attempts to initially attach to the IP wireless access network. Network device 130 may determine, based on the resource utilization information, a time for user device 110 to attempt a re-attach to the IP wireless access network when user device 110 is denied access to the IP wireless access network, and may provide the determined time to user device 110. Network device 130 may receive an application service request from user device 110 when user device 110 is provided access to the IP wireless access network, and may determine whether to accept or deny the application service request based on the application service priority configuration and/or the resource utilization information. If the application service request is denied (e.g., based on the determination), network device 130 may provide, to user device 110, a time to re-attempt the application service request. If the application service request is accepted (e.g., based on the determination), network device 130 may permit user device 110 to receive the application service via the IP wireless access network. Further details of network device 130 are provided below in connection with one or more of FIGS. 2-5.

In one example, base station 120 and/or network device 130 may provide an all IP wireless access network for user device 110. The IP wireless access network, in one implementation, may correspond to a 4G network, a Long Term Evolution (LTE) network, an advanced LTE network, etc. The LTE network may include a communications network that connects subscribers (e.g., user device 110) to a service provider (e.g., video content provider 160). In another implementation, the IP wireless access network may include a WiFi network or other access networks (e.g., an enhanced high-rate packet data (eHRPD) network or a WiMax network). In other implementations, the wireless access network may include a wireless network other than an IP wireless access network.

PCRF 140 may include one or more computation or communication devices that may provide policy control decision and flow based charging control functionalities. PCRF 140 may provide network control regarding service data flow detection, gating, quality of service (QoS) and flow based charging, etc. PCRF 140 may determine how a certain service data flow shall be treated, and may ensure that user plane traffic mapping and treatment is in accordance with a user's subscription profile.

In one example implementation, PCRF 140 may receive (e.g., from a network administrator) a priority configuration for subscribers and/or application services provided by the IP wireless access network (e.g., provided by base station 120 and/or network device 130). The subscriber priority configuration may define priorities associated with subscribers of the IP wireless access network. For example, if a first subscriber pays a higher fee than a second subscriber for services provided by the IP wireless access network, then the subscriber priority configuration may allocate resources of the IP wireless access network to the first subscriber before allocating resources to the second subscriber. The application service priority configuration may define priorities associated with application services provided by the IP wireless access network. For example, the application service priority configuration may allocate a priority to emergency services content (e.g., provided by emergency services provider 180) that is higher than a priority allocated to video content (e.g., provided by video content provider 160). Further details of PCRF 140 are provided below in connection with one or more of FIGS. 2, 4, and 5.

Network 150 may include a local area network (LAN), a wide area network (WAN), a metropolitan area network (MAN), a telephone network, such as the Public Switched Telephone Network (PSTN), an intranet, the Internet, an optical fiber (or fiber optic)-based network, a cable television network, a satellite television network, or a combination of networks.

Video content provider 160 may include one or more server devices, or other types of computation or communication devices, that gather, process, search, and/or provide information in a manner described herein. In one implementation, video content provider 160 may include a computer system, an application, a cable head-end, and/or a broadcasting device capable of providing video content (e.g., video on demand (VOD) content, high definition (HD)-VOD content, TV programming, movies, on-demand services, live television, video telephony (VT), video streaming, etc.), commercials, advertisements, instructions, and/or other information to user devices 110.

Voice provider 170 may include one or more server devices, or other types of computation or communication devices, that gather, process, search, and/or provide information in a manner described herein. In one implementation, voice provider 170 may include a computer system, an application, and/or a computation device capable of providing voice content (e.g., VoIP) and/or other information to user devices 110.

Emergency services provider 180 may include one or more server devices, or other types of computation or communication devices, that gather, process, search, and/or provide information in a manner described herein. In one implementation, emergency services provider 180 may include a computer system, an application, and/or a computation device capable of providing emergency services content (e.g., E911 services, public safety services, government security services, etc.) and/or other information to user devices 110.

Although FIG. 1 shows example components of network 100, in other implementations, network 100 may include fewer components, different components, differently arranged components, and/or additional components than those depicted in FIG. 1. Alternatively, or additionally, one or more components of network 100 may perform one or more other tasks described as being performed by one or more other components of network 100.

FIG. 2 is a diagram of example components of a device 200 that may correspond to one of the devices of network 100. As illustrated, device 200 may include a bus 210, a processing unit 220, a memory 230, an input device 240, an output device 250, and a communication interface 260.

Bus 210 may permit communication among the components of device 200. Processing unit 220 may include one or more processors or microprocessors that interpret and execute instructions. In other implementations, processing unit 220 may be implemented as or include one or more application specific integrated circuits (ASICs), field programmable gate arrays (FPGAs), or the like.

Memory 230 may include a random access memory (RAM) or another type of dynamic storage device that stores information and instructions for execution by processing unit 220, a read only memory (ROM) or another type of static storage device that stores static information and instructions for the processing unit 220, and/or some other type of magnetic or optical recording medium and its corresponding drive for storing information and/or instructions.

Input device 240 may include a device that permits an operator to input information to device 200, such as a keyboard, a keypad, a mouse, a pen, a microphone, one or more biometric mechanisms, and the like. Output device 250 may include a device that outputs information to the operator, such as a display, a speaker, etc.

Communication interface 260 may include any transceiver-like mechanism that enables device 200 to communicate with other devices and/or systems. For example, communication interface 360 may include mechanisms for communicating with other devices, such as other devices of network 100.

As described herein, device 200 may perform certain operations in response to processing unit 220 executing software instructions contained in a computer-readable medium, such as memory 230. A computer-readable medium may be defined as a physical or logical memory device. A logical memory device may include memory space within a single physical memory device or spread across multiple physical memory devices. The software instructions may be read into memory 230 from another computer-readable medium or from another device via communication interface 260. The software instructions contained in memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows example components of device 200, in other implementations, device 200 may include fewer components, different components, differently arranged components, or additional components than depicted in FIG. 2. Alternatively, or additionally, one or more components of device 200 may perform one or more other tasks described as being performed by one or more other components of device 200.

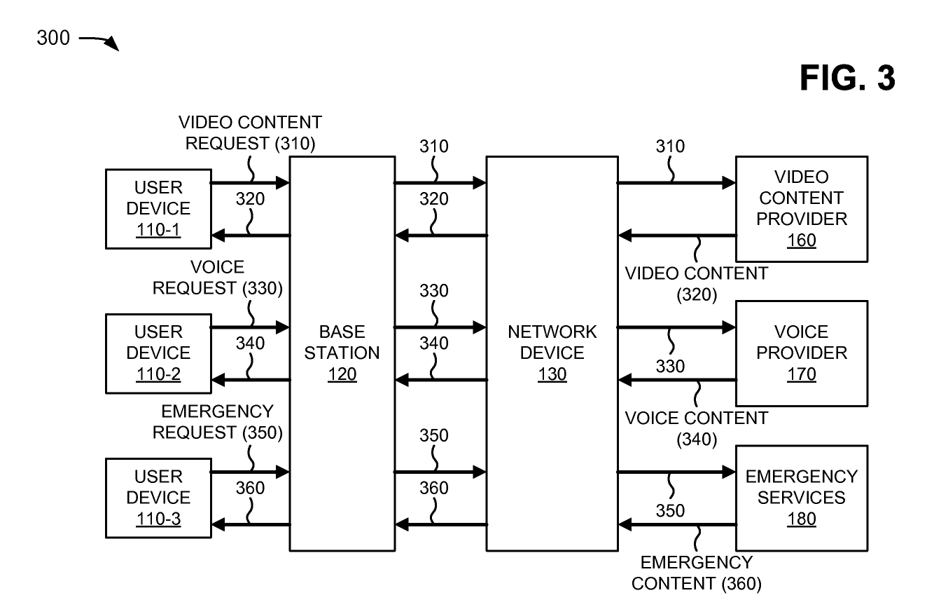

FIG. 3 is a diagram of example interactions between components of an example portion 300 of network 100. As illustrated, example network portion 300 may include user devices 110-1, 110-2, and 110-3, base station 120, network device 130, video content provider 160, voice provider 170, and emergency services provider 180. User devices 110-1, 110-2, and 110-3, base station 120, network device 130, video content provider 160, voice provider 170, and emergency services provider 180 may include the features described above in connection with one or more of FIGS. 1 and 2.

As further shown in FIG. 3, a first user (not shown) may utilize user device 110-1 to generate a request 310 for video content to be displayed on user device 110-1. For example, the first user may be viewing a menu of VOD content (e.g., via user device 110-1), and may select a video provided by the menu. User device 110-1 may wirelessly provide video content request 310 to base station 120, and base station 120 may forward video content request 310 to network device 130. Network device 130 may forward video content request 310 to video content provider 160 (e.g., via network 150, not shown). Video content provider 160 may receive video content request 310 from network device 130, may search for the requested video content (e.g., provided via video content request 310), and may provide the requested video content 320 to network device 130. Network device 130 may provide video content 320 to base station 120, and base station 120 may wirelessly provide video content 320 to user device 110-1. User device 110-1 may receive video content 320 and may display video content 320 to the first user.

A second user (not shown) may utilize user device 110-2 to generate a request 330 for voice services to be provided to user device 110-2. For example, the second user may initiate a VoIP telephone call to another user device (not shown). User device 110-2 may wirelessly provide voice request 330 to base station 120, and base station 120 may forward voice request 330 to network device 130. Network device 130 may forward voice request 330 to voice provider 170 (e.g., via network 150, not shown). Voice provider 170 may receive voice request 330 from network device 130, may search for the other user device (e.g., provided via voice request 330), and may connect user device 110-2 to the other user device. Voice provider 170 may enable user device 110-2 and the other user device to exchange voice content 340. For example, voice provider 170 may provide voice content 340 (e.g., received from the other user device) to network device 130. Network device 130 may provide voice content 340 to base station 120, and base station 120 may wirelessly provide voice content 340 to user device 110-2. User device 110-2 may receive voice content 340 and may provide voice content 340 to the second user.

A third user (not shown) may utilize user device 110-3 to generate a request 350 for emergency services to be provided to user device 110-3. For example, the third user may initiate an E911 telephone call to emergency services provider 180. User device 110-3 may wirelessly provide emergency request 350 to base station 120, and base station 120 may forward emergency request 350 to network device 130. Network device 130 may forward emergency request 350 to emergency services provider 180 (e.g., via network 150, not shown). Emergency services provider 180 may receive emergency request 350 from network device 130, and may establish a connection with user device 110-3 based on emergency request 350. For example, emergency services provider 180 may enable user device 110-3 and emergency personnel (e.g., associated with emergency services provider 180) to exchange emergency content 360 (e.g., a location of an emergency, how to handle an emergency situation, etc.). Emergency services provider 180 may provide emergency content 360 to network device 130. Network device 130 may provide emergency content 360 to base station 120, and base station 120 may wirelessly provide emergency content 360 to user device 110-3. User device 110-3 may receive emergency content 360 and may provide emergency content 360 to the third user.

In a multiple access network (e.g., such as network portion 300), different ordinary multimedia application services (e.g., video content 320, voice content 340, etc.) may compete for the same air interface and transport network resources (e.g., base station 120 and network device 130). At the same time, mission critical application services (e.g., emergency content 360, etc.) may share the same air interface and transport network resources (e.g., base station 120 and network device 130) as the ordinary multimedia application services. However, such application services may not be prioritized, which may adversely affect service provisioning and network operation. In order to address such issues, systems and/or methods described herein may provide advanced admission control (e.g., for prioritizing services) in an IP wireless access network (e.g., such as network portion 300). The systems and/or methods may provide subscriber-based and application services-based priority access to the IP wireless access network, which may ensure proper services provisioning and operation of the IP wireless access network.

Although FIG. 3 shows example components of network portion 300, in other implementations, network portion 300 may include fewer components, different components, differently arranged components, and/or additional components than depicted in FIG. 3. Alternatively, or additionally, one or more components of network portion 300 may perform one or more other tasks described as being performed by one or more other components of network portion 300.

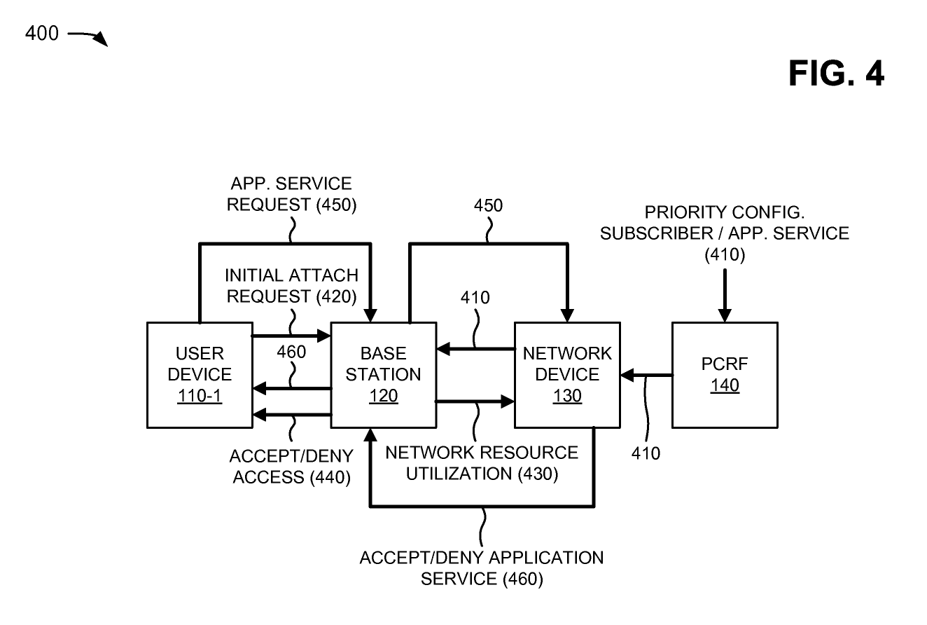

FIG. 4 is a diagram of example interactions between components of another example portion 400 of network 100. As illustrated, example network portion 400 may include user device 110-1, base station 120, network device 130, and PCRF 140. User device 110-1, base station 120, network device 130, and PCRF 140 may include the features described above in connection with one or more of FIGS. 1-3.

As shown in FIG. 4, subscriber and/or application service priority configurations 410 may be pre-provisioned in PCRF 140 (e.g., by video content provider 160, voice provider 170, emergency services provider 180, and/or other sources). Subscriber/application service priority configurations 410 may include information associated with subscribers (e.g., users of user devices 110) of video content provider 160, voice provider 170, and/or emergency services provider 180. For example, subscriber/application service priority configurations 410 may include subscriber service plan information (e.g., whether subscribers subscribe to premium services or less than premium services, data plans of subscribers, etc.); subscriber hardware information (e.g., what type(s) of user devices 110 utilized by subscribers, capabilities of such user devices 110, etc.); priorities associated with the subscribers (e.g., whether one subscriber has a higher priority over another subscriber); etc. In one implementation, subscriber priority configuration 410 may define priorities associated with subscribers of the IP wireless access network (e.g., provided by base station 120 and/or network device 130). For example, if a first subscriber pays a higher fee than a second subscriber for services provided by the IP wireless access network, then subscriber priority configuration 410 may allocate resources of the IP wireless access network to the first subscriber before allocating resources to the second subscriber.

Subscriber/application service priority configurations 410 may include information associated with application services utilized by the subscribers (e.g., users of user devices 110). For example, subscriber/application service priority configurations 410 may include information associated with emergency and/or government security services (e.g., E911 services) utilized by the subscribers; information associated with data services (e.g., real-time voice and/or video, web browsing, email, etc.) utilized by the subscribers; information associated with machine-to-machine services (e.g., short message service (SMS)) utilized by the subscribers; priorities associated with the aforementioned services (e.g., whether one application service has a higher priority than another application service); etc. In one implementation, application service priority configuration 410 may define priorities associated with application services provided by the IP wireless access network. For example, application service priority configuration 410 may allocate a priority to emergency services content (e.g., provided by emergency services provider 180) that is higher than a priority allocated to video content (e.g., provided by video content provider 160). In another example, application service priority configuration 410 may allocate the following priority order: (1) emergency services content; (2) VoIP; (3) video telephony; (4) video streaming; (5) data services; and (6) machine-to-machine services. However, application service priority configuration 410 is not limited to the aforementioned applications and/or priority orders.

PCRF 140 may provide subscriber/application service priority configurations 410 to base station 120 and/or network device 130. Alternatively, or additionally, PCRF 140 may provide subscriber/application service priority configurations 410 to network device 130, and network device 130 may provide subscriber/application service priority configurations 410 to base station 120.

As further shown in FIG. 4, a user (not shown) may utilize user device 110-1 to attempt to initially attach to the IP wireless access network (e.g., provided by base station 120 and/or network device 130), as indicated by reference number 420 (initial attach request 420). Base station 120 may monitor network resource utilization information 430 associated with the IP wireless access network (e.g., provided by base station 120 and/or network device 130). Network resource utilization information 430 may include resource utilization of base station 120, such as radio utilization of base station 120 by user devices 110, a load placed on base station 120 by user devices 110 (e.g., due to the number of user devices 110 attached to base station 120 and services utilized by the attached user devices 110), etc. When the user (e.g., via user device 110-1) provides initial attach request 420 to base station 120, base station 120 may detect initial attach request 420 and may provide network resource utilization information 430 (e.g., for the wireless access network) to network device 130. Alternatively, or additionally, base station 120 may periodically report network resource utilization information 430 to network device 130 (e.g., absent initial attach request 420).

Base station 120 may determine whether to accept or deny initial attach request 420 based on subscriber priority configuration 410 and/or network resource utilization information 430. For example, base station 120 may determine whether to accept or deny initial attach request 420 of user device 110-1 based on radio usage patterns (e.g., by other user devices 110 associated with base station 120), a priority associated with the user of user device 110-1, priorities associated with users of the other user devices 110 associated with base station 120, etc. If initial attach request 420 is denied (e.g., based on the determination and as indicated by reference number 440), base station 120 and/or network device 130 may determine and provide, to user device 110-1, a time to attempt a re-attach to the IP wireless access network (e.g., based on network resource utilization information 430). This may ensure that user device 110-1 does not keep trying to continuously attach to the IP wireless access network and create further network congestion problems. If initial attach request 420 is accepted (e.g., based on the determination and as indicated by reference number 440), base station 120 may permit user device 110-1 to access the IP wireless access network.

After user device 110-1 attaches to the IP wireless access network and as further shown in FIG. 4, user device 110-1 may generate a request 450 for an application service (e.g., an emergency service, a government security service, real-time voice and/or video, web browsing, email, SMS, etc.) to be provided to user device 110-1. User device 110-1 may wirelessly provide application service request 450 to base station 120, and base station 120 may provide application service request 450 to network device 130. Network device 130 may receive application service request 450, and may determine whether to accept or deny application service request 450 based on application service priority configuration 410 and/or network resource utilization information 430. In one implementation, network device 130 may check radio utilization reports (e.g., provided by network resource utilization information 430) and a priority class of the requested application service (e.g., provided by application service priority configuration 410), and may decide whether to accept or deny application service request 450 based on the radio utilization reports and the priority class. For example, network device 130 may prioritize emergency and/or government security application services first, may prioritize data application services (e.g., real-time voice and/or video, web browsing, email, etc.) second, and may prioritize machine-to-machine services (e.g., SMS) last.

If application service request 450 is denied (e.g., based on the determination and as indicated by reference number 460), network device 130 may provide, to user device 110 (e.g., via base station 120), a time to re-attempt application service request 450. In one example, network device 130 may determine the time to re-attempt application service request 450 based on radio usage patterns (e.g., by other user devices 110 associated with base station 120), a priority associated with the user of user device 110-1, priorities associated with users of the other user devices 110 associated with base station 120, etc. This may ensure that user device 110-1 does not keep trying to continuously access the requested application service (e.g., provided by the IP wireless access network) and create further network congestion problems. If application service request 450 is accepted (e.g., based on the determination and as indicated by reference number 460), network device 130 may permit user device 110-1 to receive the requested application service via the IP wireless access network.

Although FIG. 4 shows example components of network portion 400, in other implementations, network portion 400 may include fewer components, different components, differently arranged components, and/or additional components than depicted in FIG. 4. Alternatively, or additionally, one or more components of network portion 400 may perform one or more other tasks described as being performed by one or more other components of network portion 400.

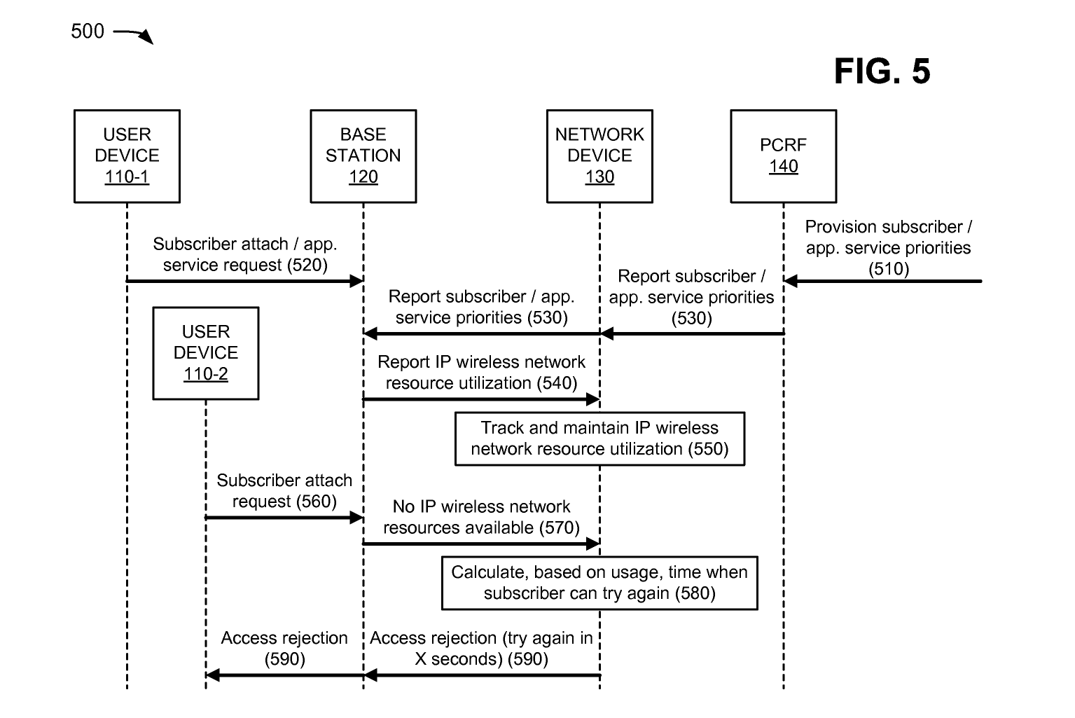

FIG. 5 is a flow diagram of example interactions between components of still another example portion 500 of network 100. As illustrated, example network portion 500 may include user devices 110-1 and 110-2, base station 120, network device 130, and PCRF 140. User devices 110-1 and 110-2, base station 120, network device 130, and PCRF 140 may include the features described above in connection with one or more of FIGS. 1-4.

As further shown in FIG. 5, subscriber and/or application service priorities may be pre-provisioned in PCRF 140 (e.g., by video content provider 160, voice provider 170, emergency services provider 180, and/or other sources), as indicated by reference number 510. In one example, the subscriber/application service priorities may include the information provided by subscriber/application service priority configurations 410.

A first user (not shown) may utilize user device 110-1 to attempt to initially attach to the IP wireless access network (e.g., provided by base station 120 and/or network device 130), as indicated by reference number 520 (subscriber attach request 520). Alternatively, if user device 110-1 is attached to the IP wireless access network, the first user may utilize user device 110-1 to request an application service, as further indicated by reference number 520 (application service request 520). When the first user (e.g., via user device 110-1) provides subscriber attach/application service request 520 to base station 120, PCRF 140 may report the subscriber/application service priorities to network device 130, as indicated by reference number 530. Network device 130 may report the subscriber/application service priorities to base station 120, as further indicated by reference number 530. Alternatively, or additionally, PCRF 140 may report the subscriber/application service priorities to base station 120 and/or network device 130.

Base station 120 may monitor network resource utilization information (e.g., network resource utilization information 430) associated with the IP wireless access network (e.g., provided by base station 120 and/or network device 130). When the first user (e.g., via user device 110-1) provides subscriber attach/application service request 520 to base station 120, base station 120 may report the network resource utilization information (e.g., for the IP wireless access network) to network device 130, as indicated by reference number 540. Alternatively, or additionally, base station 120 may periodically report the network resource utilization information to network device 130 (e.g., absent subscriber attach/application service request 520). As further shown in FIG. 5, network device 130 may track and maintain the network resource utilization associated with the IP wireless access network (e.g., provided by base station 120 and/or network device 130), as indicated by reference number 550.

A second user (not shown) may utilize user device 110-2 to attempt to initially attach to the IP wireless access network (e.g., provided by base station 120 and/or network device 130), as indicated by reference number 560 (subscriber attach request 560). When the second user (e.g., via user device 110-2) provides subscriber attach request 560 to base station 120, base station 120 may provide an indication that no resources are available (e.g., for the IP wireless access network) to network device 130, as indicated by reference number 570. Network device 130 may receive indication 570, and may calculate (e.g., based on usage of the IP wireless access network resources) a time when the second user can attempt to access the IP wireless access network, as indicated by reference number 580. Network device 130 may provide an access rejection 590 (e.g., with the calculated time, such as “try again in X seconds”) to base station 120, and base station 120 may forward access rejection 590 to user device 110-2. User device 110-2 may receive access rejection 590 and may display the calculated time (e.g., the message “try again in X seconds”) to the second user.

Although FIG. 5 shows example components of network portion 500, in other implementations, network portion 500 may include fewer components, different components, differently arranged components, and/or additional components than depicted in FIG. 5. Alternatively, or additionally, one or more components of network portion 500 may perform one or more other tasks described as being performed by one or more other components of network portion 500.

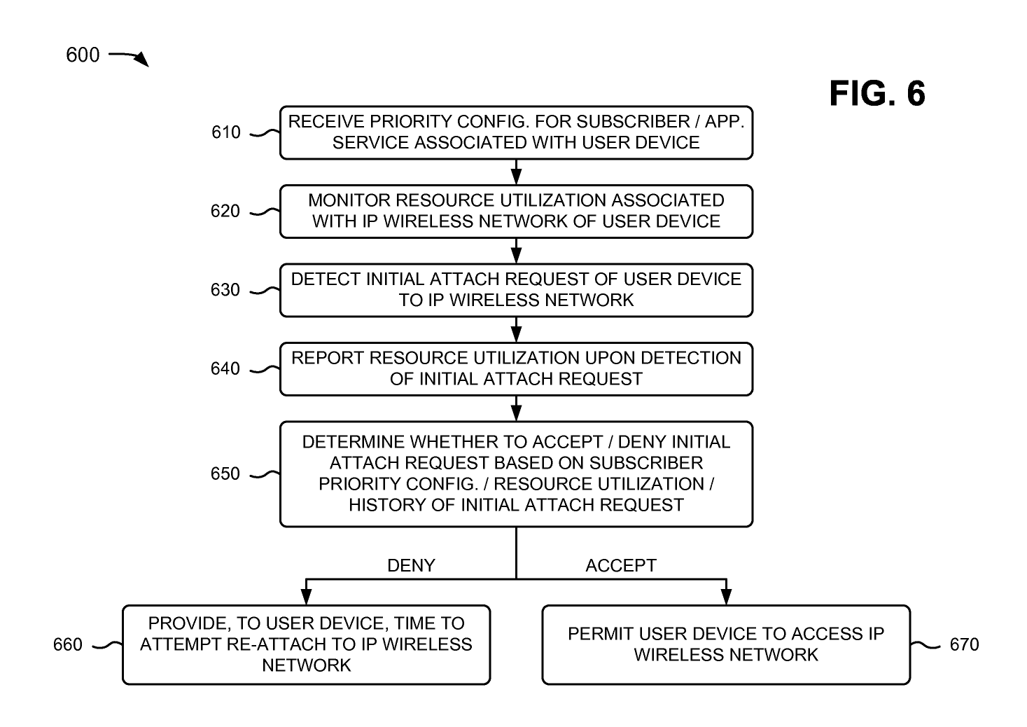

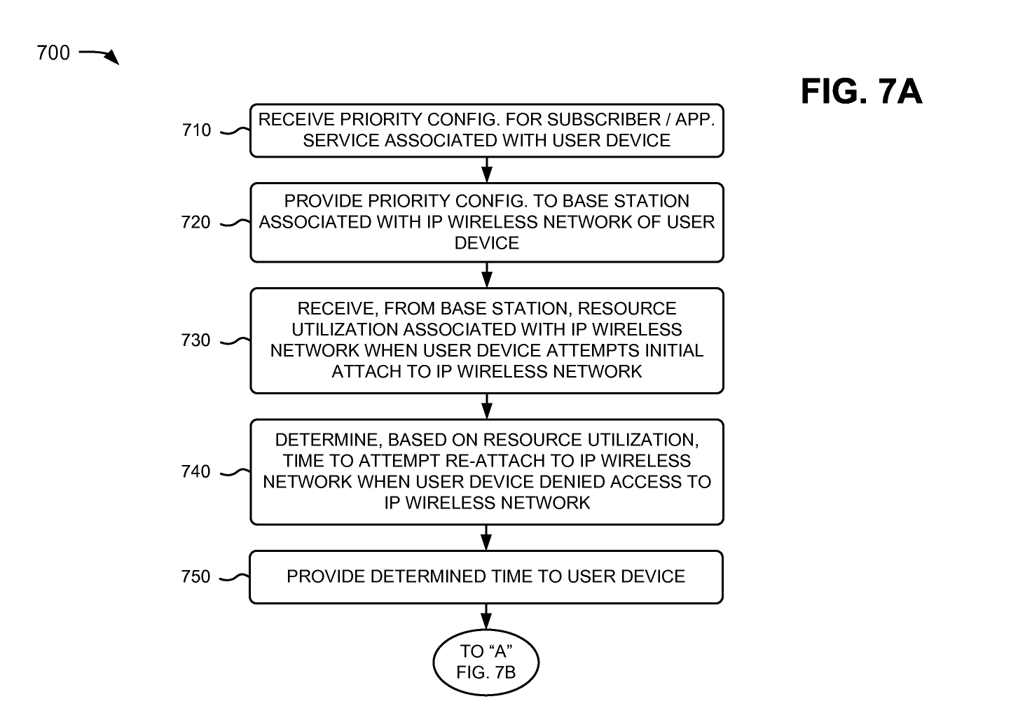

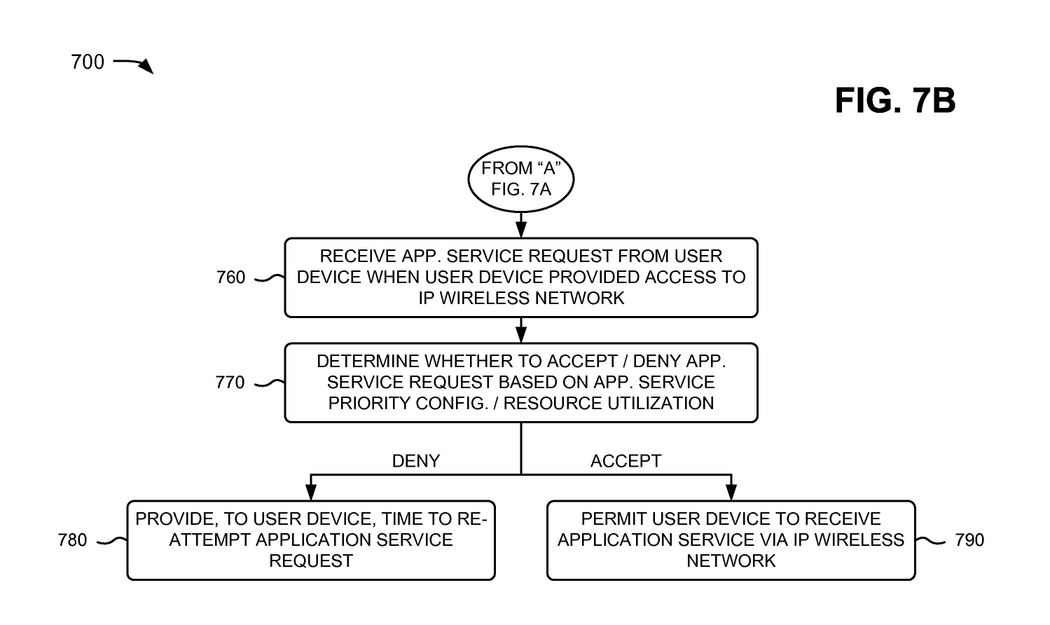

FIGS. 6-7B are flow charts of example processes 600 and 700 for providing advanced admission control over an all IP wireless access network according to implementations described herein. In one implementation, process 600 may be performed by base station 120. In another implementation, some or all of process 600 may be performed by another device or group of devices, including or excluding base station 120. In one implementation, process 700 may be performed by network device 130. In another implementation, some or all of process 700 may be performed by another device or group of devices, including or excluding network device 130.

As illustrated in FIG. 6, process 600 may include receiving a priority configuration for a subscriber and/or an application service associated with a user device (block 610), and monitoring resource utilization information associated with an IP wireless access network of the user device (block 620). For example, in implementations described above in connection with FIG. 4, PCRF 140 may provide subscriber/application service priority configurations 410 to base station 120 and/or network device 130. Alternatively, or additionally, PCRF 140 may provide subscriber/application service priority configurations 410 to network device 130, and network device 130 may provide subscriber/application service priority configurations 410 to base station 120. Base station 120 may monitor network resource utilization information 430 associated with the IP wireless access network (e.g., provided by base station 120 and/or network device 130). Network resource utilization information 430 may include resource utilization of base station 120, such as radio utilization of base station 120 by user devices 110, a load placed on base station 120 by user devices 110 (e.g., due to the number of user devices 110 attached to base station 120 and services utilized by the attached user devices 110), etc.

As further shown in FIG. 6, process 600 may include detecting an initial attach request of the user device to the IP wireless access network (block 630), and reporting the resource utilization information upon detection of the initial attach request (block 640). For example, in implementations described above in connection with FIG. 4, when the user (e.g., via user device 110-1) provides initial attach request 420 to base station 120, base station 120 may detect initial attach request 420 and may provide network resource utilization information 430 (e.g., for the wireless access network) to network device 130. Alternatively, or additionally, base station 120 may periodically report network resource utilization information 430 to network device 130 (e.g., absent initial attach request 420).

Returning to FIG. 6, process 600 may include determining whether to accept or deny the initial attach request based on the subscriber priority configuration, the resource utilization information, and/or the age or history of the initial attach request (block 650). If the initial attach request is denied (block 650—DENY), process 600 may include providing, to the user device, a time to attempt a re-attach to the IP wireless access network (block 660). If the initial attach request is accepted (block 650—ACCEPT), process 600 may include permitting the user device to access the IP wireless access network (block 670). For example, in implementations described above in connection with FIG. 4, base station 120 may determine whether to accept or deny initial attach request 420 based on subscriber priority configuration 410, network resource utilization information 430, and/or the age or the history of initial attach request 420. In one example, base station 120 may determine whether to accept or deny initial attach request 420 of user device 110-1 based on radio usage patterns (e.g., by other user devices 110 associated with base station 120), a priority associated with the user of user device 110-1, priorities associated with users of the other user devices 110 associated with base station 120, etc. If initial attach request 420 is denied (e.g., based on the determination and as indicated by reference number 440), base station 120 and/or network device 130 may provide, to user device 110-1, a time to attempt a re-attach to the IP wireless access network. If initial attach request 420 is accepted (e.g., based on the determination and as indicated by reference number 440), base station 120 may permit user device 110-1 to access the IP wireless access network.

As illustrated in FIG. 7A, process 700 may include receiving a priority configuration for a subscriber and/or an application service associated with a user device (block 710), providing the priority configuration to a base station associated with an IP wireless access network of the user device (block 720), and receiving, from the base station, resource utilization information associated with the IP wireless access network when the user device attempts an initial attach to the IP wireless access network (block 730). For example, in implementations described above in connection with FIG. 4, PCRF 140 may provide subscriber/application service priority configurations 410 to network device 130, and network device 130 may provide subscriber/application service priority configurations 410 to base station 120. When the user (e.g., via user device 110-1) provides initial attach request 420 to base station 120, base station 120 may detect initial attach request 420 and may provide network resource utilization information 430 (e.g., for the wireless access network) to network device 130. Alternatively, or additionally, base station 120 may periodically report network resource utilization information 430 to network device 130 (e.g., absent initial attach request 420).

As further shown in FIG. 7A, process 700 may include determining, based on the resource utilization information, a time to attempt re-attach to the IP wireless access network when the user device is denied access to the IP wireless access network (block 740), and providing the determined time to the user device (block 750). For example, in implementations described above in connection with FIG. 4, base station 120 may determine whether to accept or deny initial attach request 420 of user device 110-1 based on radio usage patterns (e.g., by other user devices 110 associated with base station 120), a priority associated with the user of user device 110-1, priorities associated with users of the other user devices 110 associated with base station 120, etc. If initial attach request 420 is denied (e.g., based on the determination and as indicated by reference number 440), base station 120 and/or network device 130 may determine and provide, to user device 110-1, a time to attempt a re-attach to the IP wireless access network (e.g., based on network resource utilization information 430).

As illustrated in FIG. 7B, process 700 may include receiving an application service request from the user device when the user device is provided access to the IP wireless access network (block 760). For example, in implementations described above in connection with FIG. 4, after user device 110-1 attaches to the IP wireless access network, user device 110-1 may generate request 450 for an application service (e.g., an emergency service, a government security service, real-time voice and/or video, web browsing, email, SMS, etc.) to be provided to user device 110-1. User device 110-1 may wirelessly provide application service request 450 to base station 120, and base station 120 may provide application service request 450 to network device 130. Network device 130 may receive application service request 450.

As further shown in FIG. 7B, process 700 may include determining whether to accept or deny the application service request based on the application service priority configuration and/or the resource utilization information (block 770). If the application service request is denied (block 770—DENY), process 700 may include providing, to the user device, a time to re-attempt the application service request (block 780). If the application service request is accepted (block 770—ACCEPT), process 700 may include permitting the user device to receive the application service via the IP wireless access network (block 790). For example, in implementations described above in connection with FIG. 4, network device 130 may determine whether to accept or deny application service request 450 based on application service priority configuration 410 and/or network resource utilization information 430. If application service request 450 is denied (e.g., based on the determination and as indicated by reference number 460), network device 130 may provide, to user device 110 (e.g., via base station 120), a time to re-attempt application service request 450. In one example, network device 130 may determine the time to re-attempt application service request 450 based on radio usage patterns (e.g., by other user devices 110 associated with base station 120), a priority associated with the user of user device 110-1, priorities associated with users of the other user devices 110 associated with base station 120, etc. If application service request 450 is accepted (e.g., based on the determination and as indicated by reference number 460), network device 130 may permit user device 110-1 to receive the requested application service via the IP wireless access network.

Systems and/or methods described herein may provide advanced admission control (e.g., for prioritizing services) in an IP wireless access network. The systems and/or methods may provide subscriber-based and application services-based priority access to the IP wireless access network, which may ensure proper services provisioning and operation of the IP wireless access network.

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 6-7B, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as a “component” that performs one or more functions. These components may include hardware, such as an ASIC or a FPGA, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method implemented by a computing device, the method comprising:
receiving, by the computing device, a priority configuration for a subscriber associated with a user device;
monitoring, by the computing device, resource utilization information associated with an Internet protocol (IP) wireless access network of the user device;
detecting, by the computing device, an initial attach request of the user device to the IP wireless access network;
determining, by the computing device, whether to accept or deny the initial attach request based on the subscriber priority configuration and the resource utilization information;
providing, to the user device and when the initial attach request is denied, a time for the user device to attempt a re-attach to the IP wireless access network; and
permitting, by the computing device and when the initial attach request is accepted, the user device to access the IP wireless access network.

2. The method of claim 1, further comprising:
reporting the resource utilization information to at least one other device of the IP wireless access network when the initial attach request is detected.

3. The method of claim 1, where the IP wireless access network includes a Long Term Evolution (LTE) network.

4. The method of claim 3, where the computing device comprises a base station of the LTE network.

5. The method of claim 1, where the subscriber priority configuration includes one or more of:
subscriber service plan information,
subscriber hardware information, or
a priority, associated with the subscriber, for accessing the IP wireless access network.

6. The method of claim 1, where the resource utilization information includes one or more of:
radio utilization of the computing device by one or more other user devices associated with the IP wireless access network, or
a load placed on the computing device by the one or more other user devices.

7. A method implemented by a computing device, the method comprising:
receiving, by the computing device, a priority configuration for a subscriber associated with a user device;
providing, by the computing device, the subscriber priority configuration to a base station associated with an Internet protocol (IP) wireless access network of the user device;
receiving, by the computing device and from the base station, resource utilization information associated with the IP wireless access network when the user device attempts an initial attach to the IP wireless access network;
determining, by the computing device and based on the subscriber priority configuration and the resource utilization information, a time for the user device to attempt a re-attach to the IP wireless access network when the user device is denied access to the IP wireless access network; and
providing, by the computing device, the determined time to the user device.

8. The method of claim 7, further comprising:
receiving a priority configuration for application services associated with the user device;
receiving an application service request from the user device when the user device is provided access to the IP wireless access network;
determining whether to accept or deny the application service request based on the application services priority configuration and the resource utilization information;
providing, to the user device and when the application service request is denied, a time for the user device to re-attempt the application service request; and
permitting, by the computing device and when the application service request is accepted, the user device to receive the requested application service via the IP wireless access network.

9. The method of claim 8, where the application services priority configuration includes one or more of:
information associated with emergency and government security services provided via the IP wireless access network,
information associated with data services provided via the IP wireless access network,
information associated with machine-to-machine services provided via the IP wireless access network, or
priorities associated with one or more of the emergency and government security services, the data services, or the machine-to-machine services.

10. The method of claim 9, where the application services priority configuration prioritizes the emergency and government security services over the data services, and prioritizes the data services over the machine-to-machine services.

11. The method of claim 7, where the IP wireless access network includes a Long Term Evolution (LTE) network.

12. The method of claim 11, where the computing device includes a network device of the LTE network.

13. The method of claim 7, where the subscriber priority configuration includes one or more of:
subscriber service plan information,
subscriber hardware information, or
a priority, associated with the subscriber, for accessing the IP wireless access network.

14. The method of claim 7, where the resource utilization information includes one or more of:
radio utilization of the computing device by one or more other user devices associated with the IP wireless access network, or
a load placed on the computing device by the one or more other user devices.

15. A device, comprising:
a memory to store a plurality of instructions; and
a processor to execute instructions in the memory to:
receive a priority configuration for a subscriber associated with a user device,
monitor resource utilization information associated with an Internet protocol (IP) wireless access network of the user device,
detect an initial attach request of the user device to the IP wireless access network,
report the resource utilization information to at least one other device of the IP wireless access network when the initial attach request is detected,
determine whether to accept or deny the initial attach request based on the subscriber priority configuration and the resource utilization information,
provide, to the user device and when the initial attach request is denied, a time for the user device to attempt a re-attach to the IP wireless access network, and
permit, when the initial attach request is accepted, the user device to access the IP wireless access network.

16. The device of claim 15, where the IP wireless access network includes a Long Term Evolution (LTE) network.

17. The device of claim 16, where the device comprises a base station of the LTE network.

18. The device of claim 15, where the subscriber priority configuration includes a priority of the subscriber, for accessing the IP wireless access network, among other subscribers of the IP wireless access network.

19. The device of claim 15, where the resource utilization information includes usage of one or more devices associated with the IP wireless access network.

20. A device, comprising:
a memory to store a plurality of instructions; and
a processor to execute instructions in the memory to:
receive a priority configuration for a subscriber associated with a user device,
provide the subscriber priority configuration to a base station associated with an Internet protocol (IP) wireless access network of the user device,
receive, from the base station, resource utilization information associated with the IP wireless access network,
determine, based on the resource utilization information, a time for the user device to attempt an attach to the IP wireless access network when the user device is denied access to the IP wireless access network,
provide the determined time to the user device,
receive a priority configuration for application services associated with the user device,
receive an application service request from the user device when the user device is provided access to the IP wireless access network,
determine whether to accept or deny the application service request based on the application services priority configuration and the resource utilization information,
provide, to the user device and when the application service request is denied, a time for the user device to re-attempt the application service request, and
permit, when the application service request is accepted, the user device to receive the requested application service via the IP wireless access network.

21. The device of claim 20, where the application services priority configuration includes one or more of:
information associated with emergency and government security services provided via the IP wireless access network,
information associated with data services provided via the IP wireless access network,
information associated with machine-to-machine services provided via the IP wireless access network, or
priorities associated with one or more of the emergency and government security services, the data services, or the machine-to-machine services.

22. The device of claim 21, where the application services priority configuration prioritizes the emergency and government security services over the data services, and prioritizes the data services over the machine-to-machine services.

23. The device of claim 21, where the IP wireless access network includes a Long Term Evolution (LTE) network and the device includes a network device of the LTE network.

24. The device of claim 21, where the subscriber priority configuration includes a priority of the subscriber, for accessing the IP wireless access network, among other subscribers of the IP wireless access network.

25. The device of claim 21, where the resource utilization information includes usage of one or more devices associated with the IP wireless access network.
